(19) United States
(12) Patent Application Publication
(10) Pub. No.: US 2025/0142463 A1
(43) Pub. Date: May 1, 2025

(54) USER EQUIPMENT SLICING ASSISTANCE INFORMATION

(71) Applicant: Google LLC, Mountain View, CA (US)

(72) Inventors: Jibing WANG, San Jose, CA (US); Veerendra Bhora, Fremont, CA (US)

(21) Appl. No.: 18/693,475

(22) PCT Filed: Sep. 14, 2022
(86) PCT No.: PCT/US2022/043546

§ 371 Date: Mar. 19, 2024

Related U.S. Application Data
(60) Provisional application No. 63/245,922, filed on Sep. 19, 2021.

(51) Int. Cl. H04W 48/18; H04W 48/16

(52) U.S. Cl. CPC H04W 48/18; H04W 48/16

(57) ABSTRACT

Methods, devices, systems, and means for user equipment slicing assistance information by a user equipment, UE, are described herein. The UE detects a condition of the UE (610) and, based on the detecting, evaluating one or more preferences (612). Based on evaluating the one or more preferences, the UE sends UE Slicing Assistance Information, USAI, to a core network entity (614), the USAI being based on a current network slice configuration. The UE receives, from a base station, a reduced radio resource configuration for operating using the low-throughput network slice (616) and communicates using the low-throughput network slice (618).

### CROSS-REFERENCE TO RELATED APPLICATIONS

This application claims the benefit of U.S. Provisional Patent Application No. 63/245,922, filed 19 Sep. 2021 the disclosure of which is incorporated herein by reference in its entirety.

### BACKGROUND

The evolution of wireless communication to fifth generation (5G) standards and technologies provides higher data rates and greater capacity, with improved reliability and lower latency, which enhances mobile broadband services. 5G technologies also provide new classes of service for vehicular networking, fixed wireless broadband, and the Internet of Things (IoT).

Each of these classes of service in 5G is described as a network slice that can be viewed as an end-to-end logical network that spans multiple portions of a 5G network. Each network slice can have dedicated resources in the network and provides service qualities tailored to the use case associated with the network slice, such as low latency, guaranteed bandwidth, support for long-battery-life IoT devices, and so forth. While the use of network slices provides dedicated network resources to a user equipment, the user equipment may experience local conditions that affects its ability to use these dedicated resources.

### SUMMARY

This summary is provided to introduce simplified concepts of user equipment slicing assistance information. The simplified concepts are further described below in the Detailed Description. This summary is not intended to identify essential features of the claimed subject matter nor is it intended for use in determining the scope of the claimed subject matter.

In aspects, methods, devices, systems, and means for transitioning to a low-throughput network slice by a user equipment (UE) describe a UE detecting a condition of the UE and, based on the detecting, evaluating one or more preferences. Based on evaluating the one or more preferences, the UE sends UE Slicing Assistance Information (USAI) to a core network entity, the USAI being based on a current network slice configuration. The UE receives from a base station, a reduced radio resource configuration for operating using the low-throughput network slice and communicates using the low-throughput network slice.

In other aspects, methods, devices, systems, and means for transitioning to a low-throughput network slice by a base station describe the base station communicating with a user equipment, UE, using an existing network slice and receiving, from a core network entity, a configuration for a Protocol Data Unit (PDU) session and a Quality of Service (QOS) flow configuration for a low-throughput network slice for a user equipment (UE) and configuring air interface resources for the low-throughput network slice. The base station transmits, to the UE, a resource grant for the air interface resources for the low-throughput network slice, releases one or more Data Radio Bearers (DRBs) with the UE that are not related to the low-throughput network slice, and communicates with the UE using the low-throughput network slice.

In further aspects, methods, devices, systems, and means for transitioning to a low-throughput network slice by a core network entity describe the network entity sending, to a base station, a configuration for a first Protocol Data Unit (PDU) session and first a Quality of Service (QOS) flow configuration for a network slice for communication with a user equipment and receiving UE Slicing Assistance Information (USAI) from a user equipment, the USAI being based on a current network slice configuration. Based on the USAI, the core network entity sends, to a base station, a configuration for a Protocol Data Unit (PDU) session and a Quality of Service (QOS) flow configuration for a low-throughput network slice for the UE, and uses the low-throughput network slice for communication with the UE.

### BRIEF DESCRIPTION OF THE DRAWINGS

The details of one or more aspects of user equipment slicing assistance information are described below. The use of the same reference numbers in different instances in the description and the figures indicate similar elements:

FIG. 1 illustrates an example operating environment in which aspects of user equipment slicing assistance information can be implemented.

FIG. 2 illustrates an example operating environment in which aspects of user equipment slicing assistance information can be implemented.

FIG. 3 illustrates an example device diagram of a user equipment and a serving cell base station.

FIG. 4 illustrates an example device diagram for a core network server device that can implement various aspects of a user equipment slicing assistance information.

FIG. 5 illustrates example data and control transactions between devices in accordance with aspects of user equipment slicing assistance information.

FIG. 6 illustrates an example method of user equipment slicing assistance information in accordance with aspects of the techniques described herein.

FIG. 7 illustrates an example method of user equipment slicing assistance information in accordance with aspects of the techniques described herein.

FIG. 8 illustrates an example method of user equipment slicing assistance information in accordance with aspects of the techniques described herein.

### DETAILED DESCRIPTION

In using network slicing techniques, dedicated resources are allocated across a core network and a radio access network (RAN) for data communication with a user equipment (UE). However, a UE may encounter a local operating condition, such as a low battery charge level, a thermal (overheating) condition, local radio frequency interference, in-device coexistence issues, antenna occlusion and/or antenna shadowing. Under such conditions, if the UE locally drops or throttles data communications to mitigate an operating condition, resources of the core network (e.g., dedicated control plane and data plane resources) and RAN resources (such as time/frequency air interface resources) may go unused resulting in decreased network efficiency and capacity.

An instance of a network slice can contain multiple flows of data between the network and the UE. For example, an Enhanced Mobile Broadband (eMBB) network slice may include flows for voice communication, text messaging, video streaming, and so forth. A network slice is identified by Single Network Slice Selection Assistance Information (S-NSSAI). The properties of a network slice are associated with its S-NSSAI. When a UE encounters a local operating condition that can be mitigated by changing the configuration of a network slice, the UE sends UE Slicing Assistance Information (USAI) to the network so that the network can reconfigure the network slice to support the operating conditions of the UE. For example, the USAI enables the RAN (base station) to reconfigure the air interface resources allocated to the UE to support the new/modified network slice, and the USAI also allows the core network to reallocate networking resources and support the new/modified network slice.

### Example Environments

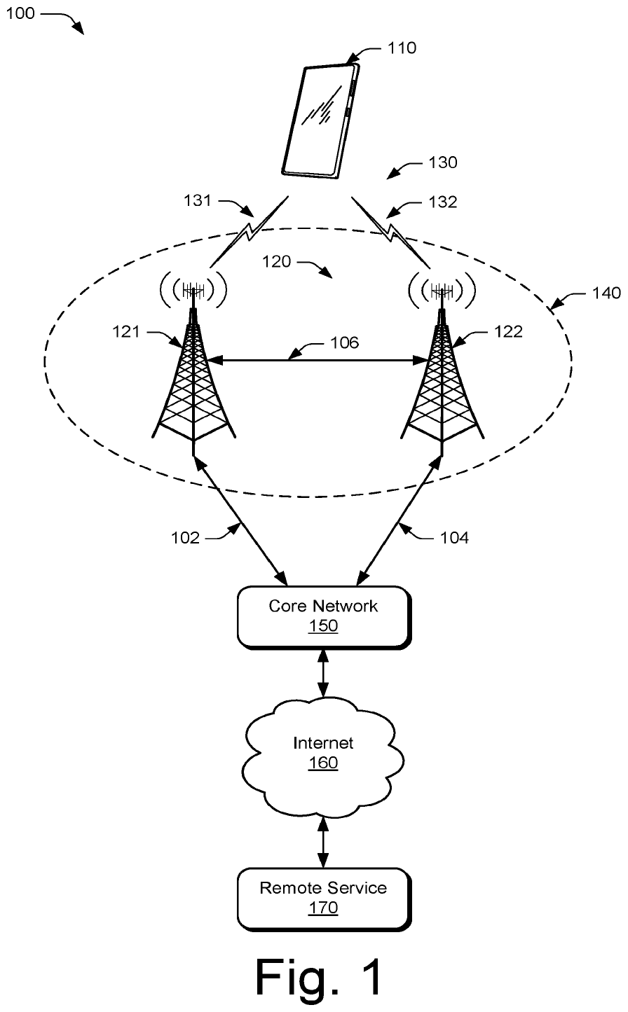

FIG. 1 illustrates an example environment 100, which includes a user equipment 110 (UE 110) that can communicate with base stations 120 (illustrated as base stations 121 and 122) through one or more wireless communication links 130 (wireless link 130), illustrated as wireless links 131 and 132. For simplicity, the UE 110 is implemented as a smartphone but may be implemented as any suitable computing or electronic device, such as a mobile communication device, modem, cellular phone, gaming device, navigation device, media device, laptop computer, desktop computer, tablet computer, smart appliance, vehicle-based communication system, or an Internet-of-Things (IoT) device such as a sensor or an actuator. The base stations 120 (e.g., an Evolved Universal Terrestrial Radio Access Network Node B, E-UTRAN Node B, evolved Node B, eNodeB, eNB, Next Generation Node B, gNode B, gNB, ng-eNB, or the like) may be implemented in a macrocell, microcell, small cell, picocell, distributed base station, and the like, or any combination or future evolution thereof.

The base stations 120 communicate with the user equipment 110 using the wireless links 131 and 132, which may be implemented as any suitable type of wireless link. The wireless links 131 and 132 include control and data communication, such as downlink of data and control information communicated from the base stations 120 to the user equipment 110, uplink of other data and control information communicated from the user equipment 110 to the base stations 120, or both. The wireless links 130 may include one or more wireless links (e.g., radio links) or bearers implemented using any suitable communication protocol or standard, or combination of communication protocols or standards, such as 3rd Generation Partnership Project Long-Term Evolution (3GPP LTE), Fifth Generation New Radio (5G NR), and so forth. In various aspects, the base stations 120 and UE 110 may be implemented for operation in sub-gigahertz bands, sub-6 GHz bands (e.g., Frequency Range 1), and/or above-6 GHz bands (e.g., Frequency Range 2, millimeter wave (mmWave) bands) that are defined by one or more of the 3GPP LTE, 5G NR, or 6G communication standards (e.g., 26 GHz, 28 GHZ, 38 GHZ, 39 GHz, 41 GHZ, 57-64 GHz, 71 GHz, 81 GHz, 92 GHz bands, 100 GHz to 300 GHz, 130 GHz to 175 GHz, or 300 GHz to 3 THz bands). Multiple wireless links 130 may be aggregated in a carrier aggregation or multi-connectivity to provide a higher data rate for the UE 110. Multiple wireless links 130 from multiple base stations 120 may be configured for Coordinated Multipoint (COMP) communication with the UE 110.

The base stations 120 are collectively a Radio Access Network 140 (e.g., RAN, Evolved Universal Terrestrial Radio Access Network, E-UTRAN, 5G NR RAN or NR RAN). The base stations 121 and 122 in the RAN 140 are connected to a core network 150. The base stations 121 and 122 connect, at 102 and 104 respectively, to the core network 150 through an NG2 interface for control-plane signaling and using an NG3 interface for user-plane data communications when connecting to a 5G core network, or using an SI interface for control-plane signaling and user-plane data communications when connecting to an Evolved Packet Core (EPC) network. The base stations 121 and 122 can communicate using an Xn Application Protocol (XnAP) through an Xn interface, or using an X2 Application Protocol (X2AP) through an X2 interface, at 106, to exchange user-plane and control-plane data. The user equipment 110 may connect, via the core network 150, to public networks, such as the Internet 160 to interact with a remote service 170.

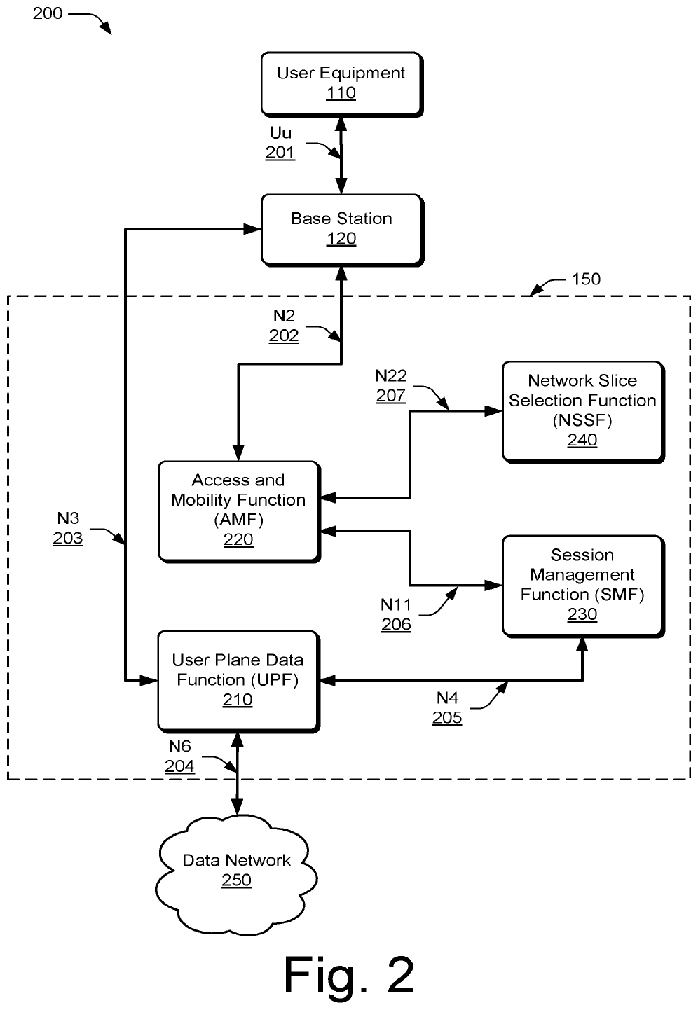

FIG. 2 illustrates an example environment 200, which illustrates aspects of the core network 150. Example functions in the core network 150 include a User Plane Function (UPF 210, an Access and Mobility Management function (AMF) 220, a Session Management Function (SMF) 230, and a Network Slice Selection Function (NSSF) 240. The core network 150 may include other functions that are omitted from FIG. 2 for illustration clarity.

The UPF 210 communicates with a data network (DN) 250, such as the Internet 160. User-plane data for the UE 110 is communicated over the Uu interface 201 (wireless link 130) to and from a base station 120, is communicated over the N3 reference point 203 between the base station 120 and the UPF 210, and is communicated to and from the DN 250 over the N6 reference point 204.

The AMF 220 provides a number of functions including registration management, connection management, reachability management, mobility management, access authentication, and access authorization. The AMF 220 conducts control-plane signaling with the base station 120 in the RAN 140 using the N2 reference point 202.

The SMF 230 provides functions that include session management, UE Internet Protocol (IP) address allocation and management, Dynamic Host Configuration Protocol (DHCP) version 4 (DHCPv4) and DHCP version 6 (DHCPv6) server and client functions, and downlink data notification. Control-plane signaling for session management is communicated between the SMF 230 and the UPF 210 using the N4 reference point 205 and between the SMF 230 and the AMF 220 using the N11 reference point 206.

The NSSF 240 is a control plane function that supports functions including: selecting the set of network slice instances serving the UE; determining the allowed NSSAI and, if needed, the mapping to the subscribed S-NSSAIs; determining the configured NSSAI and, if needed, the mapping to the subscribed S-NSSAIs; and determining the AMF Set to be used to serve the UE, or, based on configuration, a list of candidate AMF(s). The NSSF 240 provides network slicing assistance information over the N22 reference point 207 between the AMF 406 and the NSSF 240.

### Example Devices

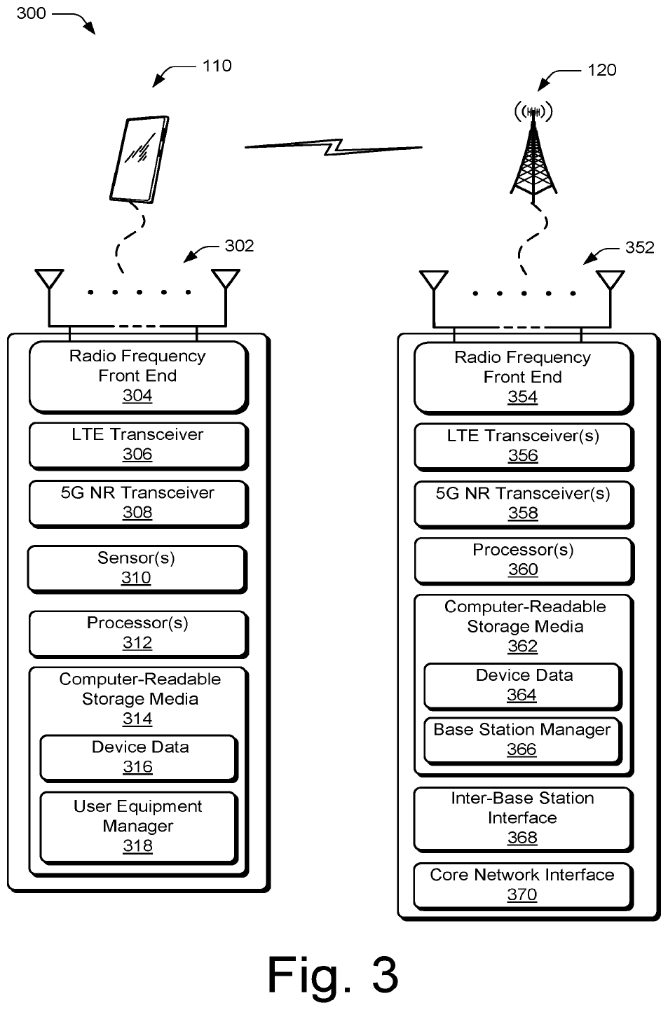

FIG. 3 illustrates an example device diagram 300 of a user equipment and a base station. In aspects, the device diagram 300 describes devices that can implement various aspects of user equipment slicing assistance information. Included in FIG. 3 are the multiple UE 110 and the base stations 120. The multiple UE 110 and the base stations 120 may include additional functions and interfaces that are omitted from FIG. 3 for the sake of clarity. The UE 110 includes antennas 302, a radio frequency front end 304 (RF front end 304), and radio-frequency transceivers (e.g., an LTE transceiver 306 and a 5G NR transceiver 308) for communicating with base stations 120 in the 5G RAN 141 and/or the E-UTRAN 142. The RF front end 304 of the UE 110 can couple or connect the LTE transceiver 306, and the 5G NR transceiver 308 to the antennas 302 to facilitate various types of wireless communication.

The antennas 302 of the UE 110 may include an array of multiple antennas that are configured similar to or differently from each other. The antennas 302 and the RF front end 304 can be tuned to, and/or be tunable to, one or more frequency bands defined by the 3GPP LTE and 5G NR communication standards and implemented by the LTE transceiver 306, and/or the 5G NR transceiver 308. Additionally, the antennas 302, the RF front end 304, the LTE transceiver 306, and/or the 5G NR transceiver 308 may be configured to support beamforming for the transmission and reception of communications with the base stations 120. By way of example and not limitation, the antennas 302 and the RF front end 304 can be implemented for operation in sub-gigahertz bands, sub-6 GHz bands, and/or above 6 GHz bands that are defined by the 3GPP LTE and 5G NR communication standards.

The UE 110 includes sensor(s) 310 can be implemented to detect various properties such as temperature, supplied power, power usage, battery state, or the like. As such, the sensors 310 may include any one or a combination of temperature sensors, thermistors, battery sensors, and power usage sensors.

The UE 110 also includes processor(s) 312 and computer-readable storage media 314 (CRM 314). The processor 312 may be a single core processor or a multiple core processor composed of a variety of materials, such as silicon, polysilicon, high-K dielectric, copper, and so on. The computer-readable storage media described herein excludes propagating signals. CRM 314 may include any suitable memory or storage device such as random-access memory (RAM), static RAM (SRAM), dynamic RAM (DRAM), non-volatile RAM (NVRAM), read-only memory (ROM), or Flash memory useable to store device data 316 of the UE 110. The device data 316 includes user data, multimedia data, beamforming codebooks, applications, and/or an operating system of the UE 110, which are executable by processor(s) 312 to enable user-plane communication, control-plane signaling, and user interaction with the UE 110.

CRM 314 also includes a user equipment manager 318 (e.g., a user equipment manager application 318). Alternately or additionally, the user equipment manager 318 may be implemented in whole or part as hardware logic or circuitry integrated with or separate from other components of the UE 110. In at least some aspects, the user equipment manager 318 configures the RF front end 304, the LTE transceiver 306, and/or the 5G NR transceiver 308 to implement the techniques described herein for user equipment slicing assistance information. In aspects, the user equipment manager 318 of the UE 110 senses UE-local conditions using the sensor(s) 310 and determines configurations of USAI to reduce data throughput in a low-throughput network slice (a new network slice defined by an S-NSSAI and used for use low-throughput communication).

The device diagram for the base stations 120, shown in FIG. 3, includes a single network node (e.g., a gNode B). The functionality of the base stations 120 may be distributed across multiple network nodes or devices and may be distributed in any fashion suitable to perform the functions described herein. The base stations 120 include antennas 352, a radio frequency front end 354 (RF front end 354), one or more LTE transceivers 356, and/or one or more 5G NR transceivers 358 for communicating with the UE 110. The RF front end 354 of the base stations 120 can couple or connect the LTE transceivers 356 and the 5G NR transceivers 358 to the antennas 352 to facilitate various types of wireless communication. The antennas 352 of the base stations 120 may include an array of multiple antennas that are configured similar to or differently from each other. The antennas 352 and the RF front end 354 can be tuned to, and/or be tunable to, one or more frequency band defined by the 3GPP LTE and 5G NR communication standards, and implemented by the LTE transceivers 356, and/or the 5G NR transceivers 358. Additionally, the antennas 352, the RF front end 354, the LTE transceivers 356, and/or the 5G NR transceivers 358 may be configured to support beamforming, such as Massive-MIMO, for the transmission and reception of communications with a UE 110.

The base stations 120 also include processor(s) 360 and computer-readable storage media 362 (CRM 362). The processor 360 may be a single core processor or a multiple core processor composed of a variety of materials, such as silicon, polysilicon, high-K dielectric, copper, and so on. CRM 362 may include any suitable memory or storage device such as random-access memory (RAM), static RAM (SRAM), dynamic RAM (DRAM), non-volatile RAM (NVRAM), read-only memory (ROM), or Flash memory useable to store device data 364 of the base stations 120. The device data 364 includes network scheduling data, radio resource management data, beamforming codebooks, applications, and/or an operating system of the base stations 120, which are executable by processor(s) 360 to enable communication with the UE 110.

CRM 362 also includes a base station manager 366 (e.g., base station manager application 366). Alternately or additionally, the base station manager 366 may be implemented in whole or part as hardware logic or circuitry integrated with or separate from other components of the base stations 120. In at least some aspects, the base station manager 366 configures the LTE transceivers 356 and the 5G NR transceivers 358 for communication with the UE 110, as well as communication with a core network. The base stations 120 include an inter-base station interface 368, such as an Xn and/or X2 interface, which the base station manager 366 configures to exchange user-plane and control-plane data between another base station 120, to manage the communication of the base stations 120 with the UE 110. The base stations 120 include a core network interface 370 that the base station manager 366 configures to exchange user-plane and control-plane data with core network functions and entities.

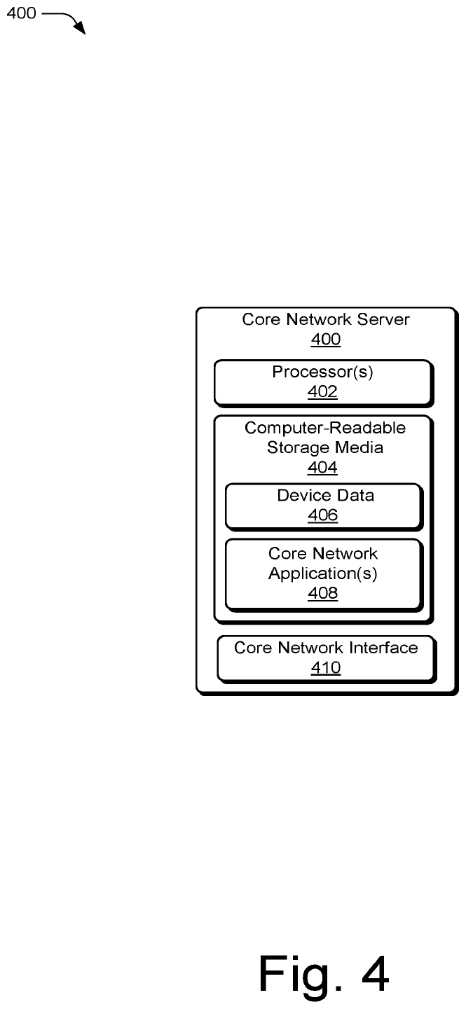

FIG. 4 illustrates an example device diagram 400 of a core network server 400. The core network server 400 may include additional functions and interfaces that are omitted from FIG. 4 for the sake of clarity. The core network server 400 may provide all or part of a function, entity, service, and/or gateway in the core network 150 (e.g., the UPF 210, the AMF 220, the SMF 230, the NSSF 240). Each function, entity, service, and/or gateway in the core network 150 may be provided as a service in the core network 150, distributed across multiple servers, or embodied on a dedicated server. For example, the core network server 400 may provide all or a portion of the services or functions of the UPF 210, the AMF 220, the SMF 230, the NSSF 240, or other core network functions. The core network server 400 is illustrated as being embodied on a single server that includes processor(s) 402 and computer-readable storage media 404 (CRM 404). The processor 402 may be a single core processor or a multiple core processor composed of a variety of materials, such as silicon, polysilicon, high-K dielectric, copper, and so on. CRM 404 may include any suitable memory or storage device such as random-access memory (RAM), static RAM (SRAM), dynamic RAM (DRAM), non-volatile RAM (NVRAM), read-only memory (ROM), hard disk drives, or Flash memory useful to store device data 406 of the core network server 400. The device data 406 includes data to support a core network function or entity, and/or an operating system of the core network server 400, which are executable by processor(s) 402.

CRM 404 also includes one or more core network applications 408, which, in one implementation, is embodied on CRM 404 (as shown). The one or more core network applications 408 may implement the functionality of the UPF 210, the AMF 220, the SMF 230, the NSSF 240, or other core network functions. Alternately or additionally, the one or more core network applications 408 may be implemented in whole or part as hardware logic or circuitry integrated with or separate from other components of the core network server 400. The core network server 400 also includes a core network interface 410 for communication of user-plane and control-plane data with the other functions or entities in the core network 150 or base stations 120, using any of the network interfaces described herein.

### User Equipment Slicing Assistance Information

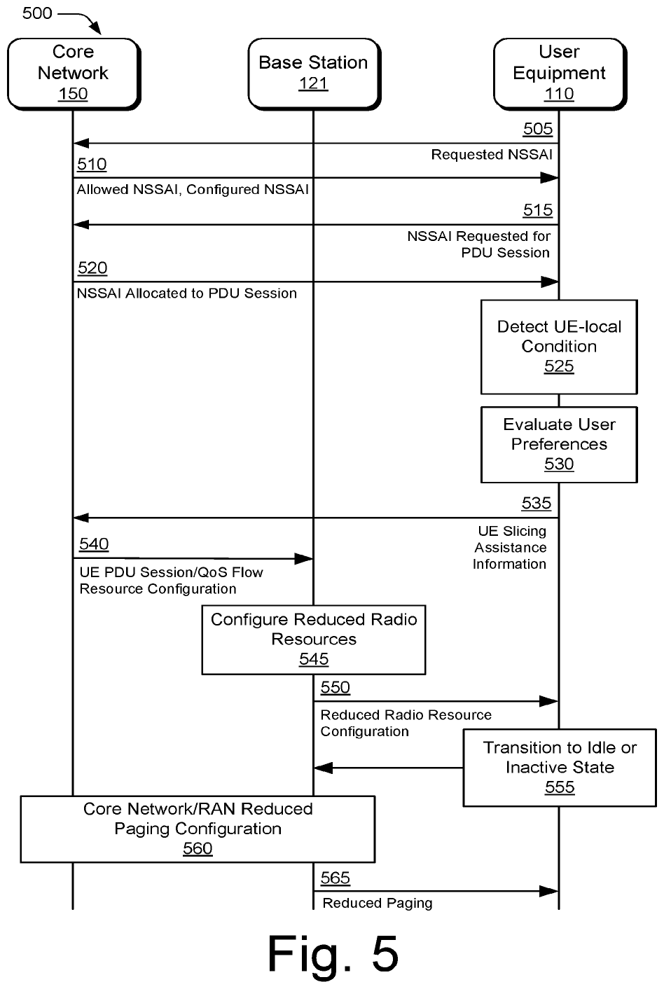

FIG. 5 illustrates data and control transactions between a UE, base station, and core network in accordance with aspects of user equipment slicing assistance information. Although not illustrated for the sake of illustration clarity, various acknowledgements for messages illustrated in FIG. 5 may be implemented to ensure reliable operations of user equipment slicing assistance information.

At 505, after the UE 110 has completed a Radio Resource Control (RRC) setup, the UE 110 sends requested Network Slice Selection Assistance Information (NSSAI) that includes one or more S-NSSAI to the core network to indicate the one or more network slices that the UE 110 wants to establish with the core network. For example, the UE 110 sends the requested NSSAI in a Network Access Stratum (NAS) Registration Request message to the AMF 220 in the core network. The AMF 220 passes the requested NSSAI to the NSSF 240 over the N22 reference point. The NSSF 240 allows and configures the network slices from the requested NSSAI.

At 510, core network 150 sends the allowed NSSAI and the configured NSSAI to the UE 110. For example, the AMF 220 receives the allowed NSSAI and the configured NSSAI from the NSSF 240 over the N22 reference point, and the AMF 220 forwards the allowed NSSAI and the configured NSSAI to the UE 110 in a NAS Registration Accept message.

At 515, the UE 110 sends a NAS Protocol Data Unit (PDU) Session Establishment Request to the core network. The NAS PDU Session Establishment Request can include an NSSAI requested for a PDU session. For example, UE 110 sends the NAS PDU Session Establishment Request to the AMF 220 that forwards the NAS PDU Session Establishment Request to the SMF 230 over the N11 reference point.

At 520, the core network sends a NAS PDU Session Establishment Response to the UE 110. The NAS PDU Session Establishment Response includes the S-NSSAI allocated to the PDU session. For example, the AMF 220 receives the NAS PDU Session Establishment Response from the SMF 230 over the N11 reference point and forwards the NAS PDU Session Establishment Response to the UE 110.

After the UE has established network slices for data communication (at 505, 510, 515, and 520), a UE-local condition (e.g., battery charge level, overheating) may occur that the UE can mitigate by reducing the amount of data transmitted and/or received by the UE. To indicate that the UE-local condition affects the UE's ability to transmit and/or receive data, the UE 110 transmits UE Slicing Assistance Information (USAI) message to the core network. The USAI includes a UE-selected slice (indicated by its S-NSSAI) as well as bearer and/or QoS flow information within the UE-selected slice. For example, when the UE 110 detects that the battery charge level is low, the UE sends a USAI message indicating that the UE wants to maintain only voice calling capabilities in a network slice, such as the eMBB network slice. When the UE-local condition has resolved, the UE 110 can send another USAI message to the core network that indicates the UE wants to resume an increased, or the original, level of service for the network slice.

The USAI augments the NSSAI and provides the UE with the capability of fine-tuning network slicing capabilities on a short-term basis, such as deleting flows in a network slice, and/or reducing throughput of the network slice, that are not included in the requested NSSAI or S-NSSAI. While the network does not need to know the UE-local condition that causes the UE to send the USAI message, the network can reallocate resources freed by the updated network slice configuration (as a result of the USAI) to allocate to other UEs.

In one aspect, the UE can include low-throughput network slice request information in the USAI. The low-throughput network slice is a UE-requested network slice that is customized by the UE and enables a service level that is dynamically determined by the UE. In the low-throughput network slice request, the USAI indicate a maximum slicing data throughput. In one alternative, the UE uses the low-throughput network slice request to request a customized S-NSSAI with a specific Slice/Service type (SST) and one or more Slice Differentiators (SD). The ST is an 8-bit value that is associated with a set of features and services provided by a network slice. The SD is a 24-bit value that is an optional information parameter that complements the slice or service type (SST) to differentiate amongst multiple network slices of same slice or service type (SST) value.

At 525, for example, the UE 110 detects a UE-local condition (e.g., a battery or thermal condition) and determines to reduce data throughput (e.g., reduce downlink throughput to 1 Mbps and/or reduce uplink throughput to 500 kbps) to mitigate the condition. The throughput is the application layer throughput, aggregated across all applications on the UE, as seen at layer three between the UPF 210 and the UE.

In one option, the user of the UE 110 can select which applications to use (and which to disable) when the UE-local condition exists. The user can preconfigure the selected applications before the UE-local condition exists or can be presented with the options for application selection in a user interface of the UE 110 at the time the UE-local condition is detected. For example, the user can select to maintain voice calling and text messaging while discontinuing video streaming or video conferencing.

At 530, the UE 110 evaluates user preferences for applications/services to maintain during the UE-local condition. For example, the operating system of the UE 110, determines the data throughput requirements of each application/service selected by the user to determine an aggregate application layer data throughput to indicate in a USAI message to the core network for either a modification of an existing network slice or a request for a low-throughput network slice.

At 535, the UE 110 sends the USAI message to the core network 150. For example, the UE 110 sends the USAI message to the AMF 220 in the core network 150. The core network 150 uses the received USAI message to determine a PDU session and QoS flow configuration for the UE 110.

At 540, the core network 150 sends UE PDU session and QoS flow resource configurations to the base station 121. Based on the UE PDU session configuration and QoS flow resource configuration, the core network releases PDU sessions and QoS flows that are no longer in use by the UE 110.

At 545, the base station 121 configures reduced air interface resources for the UE 110 based on the configuration changes received at 540. At 550, the base station 121 sends the reduced air interface resource configuration to the UE in a resource grant.

In an another aspect, when the UE-local condition exists and the UE 110 is in the RRC idle or RRC inactive state, the core network 150 and the RAN 140 can determine to ignore paging the UE 110 unless the paging is for a voice call or other prioritized applications, such as those indicated by the user preferences at 530. At 555 for example, the UE 110 transitions to an idle or inactive state. At 560, the core network 150 and the RAN 140 configure a network slice that includes a reduced paging configuration for the UE 110. The reduced paging configuration can include ignoring non-prioritized flows (e.g., ignoring all flows except a voice call flow, a video call in audio-only mode, a video call at low resolution, and the like) and/or increasing the discontinuous reception (DRX) interval (e.g., from 160 ms to 320 ms or 640 ms). At 565, the RAN sends reduced paging communications to the UE 110, such as a notification of an incoming voice call.

### Example Methods

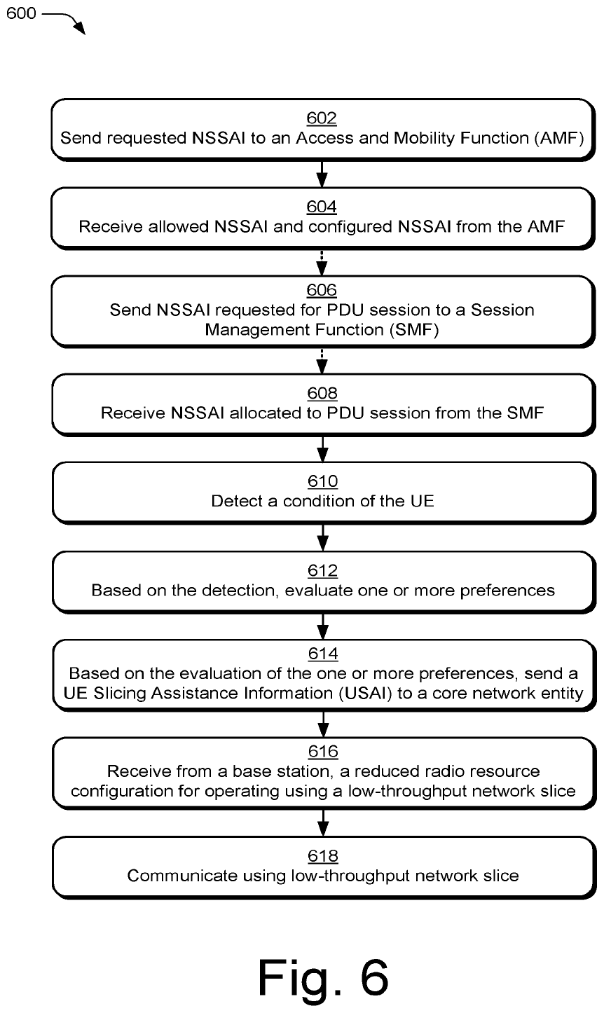

FIGS. 6-8 illustrates example method(s) 600-800 of user equipment slicing assistance information. FIG. 6 illustrates method 600 that generally relates to the user equipment configuring UE slicing assistance information. At 602, a user equipment (e.g., the UE 110) sends a requested NSSAI message to the AMF (e.g., the AMF 220) in the core network (e.g., the core network 150). For example, the UE sends the requested NSSAI, that includes one or more S-NSSAI, in a Network Access Stratum (NAS) Registration Request message to an AMF, as described at 505 of FIG. 5.

At 604, the UE receives an allowed NSSAI and configured NSSAI from the AMF in the core network. For example, the UE receives the allowed NSSAI and the configured NSSAI to the UE 110 in a NAS Registration Accept message, as described at 510 of FIG. 5.

Optionally at 606, the UE sends a NAS Protocol Data Unit (PDU) Session Establishment Request includes a NSSAI requested for a PDU session to the core network. For example, the UE sends the NAS PDU Session Establishment Request to the SMF 230, as described at 515 of FIG. 5.

At 608, the UE receives the configured Receive NSSAI allocated to the PDU session. For example, the UE receives a NAS PDU Session Establishment Response that includes the Receive NSSAI allocated to PDU session from the SMF 230, as described at 520 of FIG. 5.

At 610, the UE detects a condition of the UE. For example, the UE detects a UE-local condition, such as a low battery charge level or a thermal condition, as described at 525 of FIG. 5.

At 612, based on detecting the condition, the UE evaluates one or more preferences. For example, the UE evaluates preferences provided by a user to determine an aggregate throughput for the applications selected by the user, as described at 530 of FIG. 5.

At 614, based on the evaluation of the one or more preferences, the UE sends UE Slicing Assistance Information, USAI, to a core network entity. The UE bases the USAI on a current network slice configuration. For example, the UE sends USAI for a low-throughput network slice (either a new network slice or a change to a current network slice) to a core network entity, such as an NSSF (e.g., the NSSF 240), that indicates changes to the S-NSSAI based on the evaluation of preferences provided by the user, as described at 535 of FIG. 5.

At 616, the UE receives from a base station (e.g., the base station 121), a reduced radio resource configuration for operating using the low-throughput network slice. For example, the UE receives a resource grant from the base station that indicates air interface resources for the low-throughput network slice, as described at 550 of FIG. 5.

At 618, the UE communicates using the low-throughput network slice. For example, the UE 110 communicates with the base station using the reduced radio resource configuration for the low-throughput network slice.

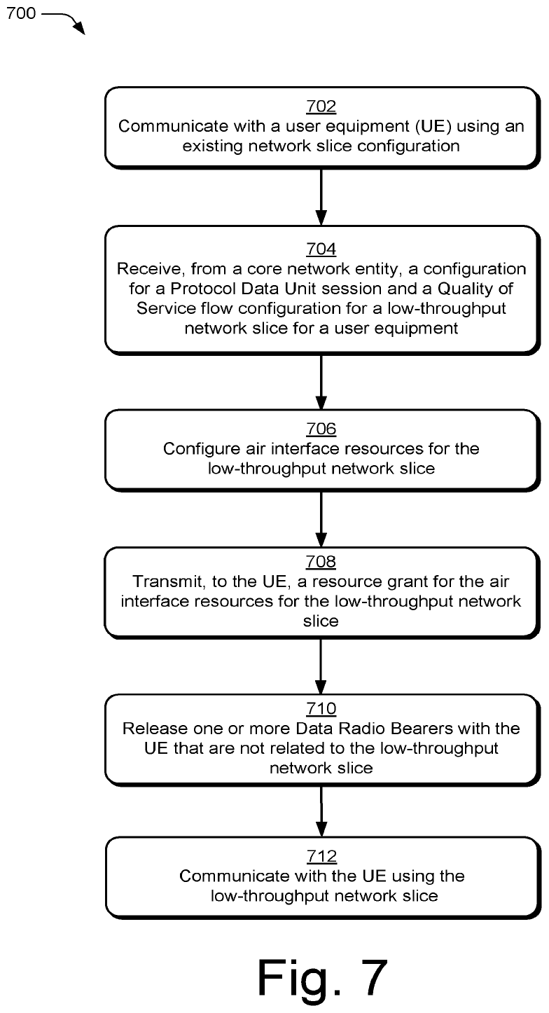

FIG. 7 illustrates method 700 that generally relates to the base station configuring communications based on the UE slicing assistance information. At 702, a base station (e.g., the base station 121) communicates with a user equipment (e.g., the UE 110) using an existing network slice configuration. For example, the base station communicates with the UE using an existing network slice, such as a mobile broadband network slice.

At 704, the base station receives, from a core network entity (e.g., the AMF 220, the SMF 230, the NSSF 240), a configuration for a Protocol Data Unit (PDU) session and a Quality of Service (QOS) flow configuration for a low-throughput network slice for a user equipment. For example, the base station receives a UE PDU Session/QoS Flow Resource Configuration from the core network (e.g., the core network 150) for a low-throughput network slice for the UE.

At 706, the base station configures air interface resources for a low-throughput network slice. For example, using the PDU Session/QoS Flow Resource Configuration, the base station determines a reduced allocation of air interface resources that is sufficient to support the low-throughput network slice, as described at 545 of FIG. 5.

At 708, The base station transmits, to the UE, a resource grant for the air interface resources for the low-throughput network slice. For example, the base station transmits a resource grant that indicates the reduced allocation of air interface resources that is sufficient to support the low-throughput network slice, as described at 550 in FIG. 5

At 710, the base station releases one or more Data Radio Bearers (DRBs) with the UE that are not related to the low-throughput network slice. For example, based on the configuration for the PDU session and a QoS flow configuration, the base station determines which DRBs are not used by the low-throughput network slice and releases those DRBs.

At 712, the base station communicates with the UE using the low-throughput network slice. For example, the base station communicates with the UE using the reduced radio resource configuration for the low-throughput network slice.

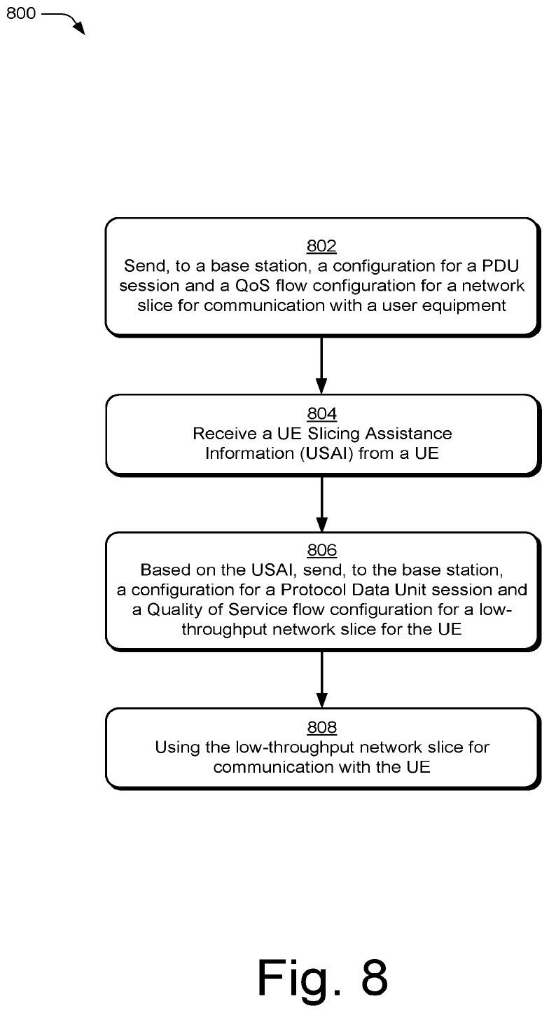

FIG. 8 illustrates method 800 that generally relates to the core network configuring communications based on the UE slicing assistance information. At 802, a core network entity sends, to a base station (e.g., the base station 121), a configuration for a Protocol Data Unit (PDU) session and a Quality of Service (QOS) flow configuration for a network slice for communication with a user equipment (e.g., the UE 110). For example, a core network entity (e.g., the AMF 220, the SMF 230, the NSSF 240) sends a configuration for a PDU session and a QoS flow configuration for a network slice, such as a mobile broadband network slice, to a base station for communications with a user equipment.

At 804, a core network entity receives a UE Slicing Assistance Information (USAI) from a UE (e.g., the UE 110), the USAI being based on a current network slice configuration. For example, a core network entity (e.g., the AMF 220, the SMF 230, the NSSF 240) receives a USAI from the UE that indicates a configuration for a low-throughput network slice, as described at 535 of FIG. 5.

At 806, based on the USAI, the core network entity sends, to the base station, a configuration for a Protocol Data Unit (PDU) session and a Quality of Service (QOS) flow configuration for the low-throughput network slice for the UE. For example, the core network entity sends to the base station a configuration for a PDU session and a QoS flow configuration for the low-throughput network slice for the UE.

At 808, the core network entity communicates with the UE using the low-throughput network slice. For example, the core network entity communicates with the UE using the reduced radio resource configuration for the low-throughput network slice.

Example methods 600-800 are described with reference to FIGS. 6-8 in accordance with one or more aspects of user equipment slicing assistance information. The order in which the method blocks are described are not intended to be construed as a limitation, and any number of the described method blocks can be skipped, repeated, or combined in any order to implement a method or an alternate method. Generally, any of the components, modules, methods, and operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like.

In the following some examples are described:

Example 1: A method for transitioning to a low-throughput network slice by a user equipment, UE, the method comprising:
detecting a condition of the UE;
based on the detecting, evaluating one or more preferences;
based on the evaluating the one or more preferences, sending UE Slicing Assistance Information, USAI, to a core network entity, the USAI being based on a current network slice configuration;
receiving from a base station, a reduced radio resource configuration for operating using the low-throughput network slice; and
communicating using the low-throughput network slice.
   Example 2: The method of example 1, wherein the sending the USAI to the core network entity comprises:
sending a USAI to the core network entity that includes an indication of a low-power slice request.
   Example 3: The method of example 2, wherein the indication of the low-power slice requests includes a slice/service type, SST, and a slice differentiator, SD.
   Example 4: The method of any one of the preceding examples, wherein the one or more preferences include user preferences.
   Example 5: The method of example 4, wherein the evaluating the one or more preferences includes:
presenting an indication of the condition to a user on a user interface of the UE; and
receiving, using the user interface, one or more inputs indicating one or more services to discontinue while using the low-throughput network slice.
   Example 6: The method of example 1, wherein the evaluating the one or more preferences comprises:
evaluating a previously selected set of services to discontinue while using the low-throughput network slice.
   Example 7: The method of any one of examples 1 to 3, wherein the evaluating the one or more preferences includes:
an operating system of the UE determining services to discontinue in order to reduce data throughput to a throughput level supported by the low-throughput network slice.
   Example 8: The method of any one of the preceding examples, wherein the low-throughput network slice is:
a new network slice; or
a modified version of an existing network slice.
   Example 9: The method of any one of the preceding examples, wherein the condition of the UE is:
a battery condition;
a temperature condition;
radio frequency interference;
an in-device coexistence issue;
antenna occlusion; or
antenna shadowing.
   Example 10: The method of any one of the preceding examples, wherein the USAI includes one or more of:
a requested data throughput for the UE;
a requested reliability for the low-throughput network slice; or
a requested level of security for the low-throughput network slice.
   Example 11: The method of any one of the preceding examples, wherein the USAI indicates a reduced level of service for the low-throughput network slice relative to the current network slice configuration.
   Example 12: A method for transitioning to a low-throughput network slice by a base station, the method comprising:
communicating with a user equipment, UE, using an existing network slice;
receiving, from a core network entity, a configuration for a Protocol Data Unit, PDU, session and a Quality of Service, QoS, flow configuration for a low-throughput network slice for a user equipment, UE;
configuring air interface resources for the low-throughput network slice;
transmitting, to the UE, a resource grant for the air interface resources for the low-throughput network slice;
releasing one or more Data Radio Bearers, DRBs, with the UE that are not related to the low-throughput network slice; and
communicating with the UE using the low-throughput network slice.
   Example 13: The method of example 12, further comprising:
flushing a data buffer not related to the low-throughput network slice.
   Example 14: The method of example 12, wherein the configuration for the PDU session and the QoS flow configuration for low-throughput network slice is based on a data throughput requirement of the UE.
   Example 15: The method of example 12, further comprising:
transitioning the UE to an inactive or an idle Radio Resource Control, RRC, state;
receiving, from the core network entity, a reduced paging configuration for the UE; and
sending the reduced paging configuration to the UE.
   Example 16: The method of example 15, wherein the reduced paging configuration for the UE includes a lengthened Discontinuous Reception, DRX, period.
   Example 17: A method for transitioning a user equipment, UE, to a low-throughput network slice by a core network entity, the method comprising:
sending, to a base station, a configuration for a first Protocol Data Unit, PDU, session and first a Quality of Service, QoS, flow configuration for a network slice for communication with a user equipment;
receiving a UE Slicing Assistance Information, USAI, from the UE, the USAI being based on a current network slice configuration;
based on the USAI, sending, to the base station, a configuration for a second PDU session and a second QoS flow configuration for a low-throughput network slice for the UE; and
using the low-throughput network slice for communication with the UE.
   Example 18: The method of example 17, further comprising:
flushing a data buffer not related to the low-throughput network slice.
   Example 19: The method of example 17, wherein the configuration for the second PDU session and the second QoS flow configuration for low-throughput network slice is based on a data throughput requirement of the UE.
   Example 20: The method of example 17, further comprising:
transitioning the UE to an inactive or an idle Radio Resource Control, RRC, state; and
sending, to the base station, a reduced paging configuration for the UE.
   Example 21: The method of example 20, wherein the reduced paging configuration for the UE includes a lengthened Discontinuous Reception, DRX, period.
   Example 22: An apparatus comprising:
a wireless transceiver;
a processor; and
computer-readable storage media comprising instructions that, responsive to execution by the processor, direct the apparatus to perform a method as recited in any one of examples 1 to 21.
   Example 23: Computer-readable storage media comprising instructions that, responsive to execution by a processor, direct an apparatus to perform a method as recited in any one of examples 1 to 21.

Although aspects of user equipment slicing assistance information have been described in language specific to features and/or methods, the subject of the appended claims is not necessarily limited to the specific features or methods described. Rather, the specific features and methods are disclosed as example implementations of user equipment slicing assistance information, and other equivalent features and methods are intended to be within the scope of the appended claims. Further, various different aspects are described, and it is to be appreciated that each described aspect can be implemented independently or in connection with one or more other described aspects.

1. A method for transitioning from a network slice to an updated network slice by a user equipment, UE, the method comprising:
detecting a local operating condition of the UE causing a low throughput;
sending, to a core network entity, UE Slicing Assistance Information, USAI, requesting the core network entity to transition the UE from the network slice to the updated network slice and indicating, based on the local operating condition, a reduced number of radio resources for the updated network slice relative to the network slice;
receiving, from a base station, a configuration for the reduced number of radio resources of the updated network slice; and
communicating using the updated network slice.

2. The method of claim 1, wherein the USAI includes an indication that the updated network slice is a low-power slice.

3. (canceled)

4. The method of claim 1, further comprising: evaluating a user preference for at least one of: an application or a service, the USAI being configured based on the user preference,
wherein the evaluating the user preferences includes:
presenting an indication of the local operating condition on a user interface of the UE; and
receiving, via the user interface, an inputs indicating a services to be discontinued in view of the local operating condition.

5. The method of claim 4, wherein the evaluating the user preferences comprises:
evaluating a previously selected set of services; and
selecting a subset of the previously selected set of services to be discontinued in view of the local operating condition.

6. The method of claim 1, wherein the updated network slice is:
a new network slice; or
a modified version of an existing network slice.

7. The method of claim 1, wherein the local operating condition of the UE is:
a battery condition;
a temperature condition;
an in-device coexistence issue;
an antenna occlusion; or
an antenna shadowing.

8. The method of claim 1, wherein the USAI includes one or more of:
a requested data throughput for the UE;
a requested reliability for the updated network slice; or
a requested level of security for the updated network slice.

9. The method of claim 1, further comprising:
detecting that the local operating condition causing the low throughput is resolved; and
sending, to the core network entity, an additional USAI requesting to resume UE communication on at least a subset of the reduced number of radio resources.

10. A method performed by a base station for transitioning a user equipment, UE, from a current network slice to an updated network slice, the method comprising:
communicating, with the UE, using the current network slice;
receiving, from a core network entity, a configuration for a Protocol Data Unit, PDU, session and a Quality of Service, QoS, flow for the updated network slice, the updated network slice including a reduced number of radio resources relative to the current network slice;
configuring air interface resources for the updated network slice;
transmitting, to the UE, a resource grant for the air interface resources;
releasing a Data Radio Bearer, DRB, with the UE that is not being used for the updated network slice; and
communicating, with the UE, using the updated network slice.

11. The method of claim 10, wherein the configuration for the PDU session and the QoS flow for the updated network slice is based on a data throughput requirement of the UE.

12. The method of claim 10, further comprising:
receiving, from the core network entity, a paging configuration for the UE, the paging configuration being for the reduced number of radio resources; and
sending, to the UE, the reduced paging.

13. The method of claim 12, wherein the paging configuration includes a second Discontinuous Reception, DRX, period that is longer than a first DRX period for another paging configuration associated with the current network slice.

14. A method performed by a core network entity for transitioning a user equipment, UE, from a current network slice to an updated network slice, the method comprising:
sending, to a base station, a configuration for a first Protocol Data Unit, PDU, session and first a Quality of Service, QoS, flow for the current network slice;
receiving, from the UE, UE Slicing Assistance Information, USAI, using the current network slice, the USAI requesting the core network entity to transition the UE from the current network slice to the updated network slice and indicating a reduced number of radio resources for the updated network slice relative to the current network slice; and
sending, to the base station, a configuration for a second PDU session and a second QoS flow for the updated network slice.

15. The method of claim 14, further comprising:
sending, to the base station, a paging configuration for the UE, the paging configuration being for the reduced number of radio resources.

16. (canceled)

17. The method of claim 14, further comprising:
flushing a data buffer not related to the updated network slice.

18. The method of claim 14, wherein the configuration for the second PDU session and the second QoS flow for the updated network slice is based on a data throughput requirement of the UE.

19. The method of claim 18, wherein the reduced paging configuration for the UE includes a lengthened Discontinuous Reception, DRX, period.

20. The method of claim 10, further comprising: flushing a data buffer not related to the updated network slice.
